(19) United States
(12) Patent Application Publication
(10) Pub. No.: US 2020/0410244 A1
(43) Pub. Date: Dec. 31, 2020

(54) System for quantitative analysis of educational activities of a child

(71) Applicant: Misun Jo, Yongin (KR)

(72) Inventor: Misun Jo, Yongin (KR)

(21) Appl. No.: 16/844,754

(22) Filed: Apr. 9, 2020

(30) Foreign Application Priority Data
Jun. 27, 2019 (KR) 10-2019-0076781

(51) Int. Cl. G06K 9/00; G09B 19/00

(52) U.S. Cl. CPC G06K 9/00771; G06K 9/00241; G09B 19/00

(57) ABSTRACT

The present invention is about a system for quantitative analysis of educational activities of a child comprising: a communication module, an intermediary module and an analysis a server. More specifically, it is about the technology to quantitatively analyze the time of occupancy in the various stations (language & literature, mathematics/puzzles, science, art, role play, water/sand play, sculpture, blocks, music, woodworking and computer station) based on data received from wireless communication devices carried on a child in an educational facility.

### CROSS-REFERENCE TO RELATED APPLICATIONS

The present application claims the benefit of Korean Patent Application No. 10-2019-0076781 filed Jun. 27 2019. The application is incorporated herein by reference.

### TECHNICAL FIELD

The present invention is about a system for quantitative analysis of educational activities of a child. More specifically, it is about the technology to quantitatively analyze the time of occupancy in the various stations (language & literature, mathematics/puzzles, science, art, role play, water/sand play, sculpture, blocks, music, woodworking and computer station) based on data received from wireless communication devices carried on a child in an educational facility.

### BACKGROUND TECHNOLOGY

Childhood education should help develop the characteristics of a child. Children are constantly learning through activities and play. Early childhood education takes part in the development of a child's interests, curiosity, developmental characteristics, and sociocultural environment.

In childhood education, education evaluation is important in that it identifies the state of development of children. In order to prepare and provide the necessary stimuli for children, it is important to identify the current level and development of children, which is an important function of assessment in childhood education.

According to the content of the educational evaluation, children can be classified into the cognitive domain evaluation (also called intellectual domain), emotional domain evaluation, and psychomotor domain evaluation.

First, the cognitive domain refers to the domain of content that can be learned through rational thinking, such as facts, concepts, laws, and academic performance assessments.

Second, the emotional domain refers to the domain of content that can be learned through the action of emotions such as personality, interests, and values, and include the assessment of interest and emotional intelligence.

Third, the psychomotor domain refers to the domain of content that can be learned through path of each part of the body, and is an evaluation of singing, playing a musical instrument, art, physical education, etc.

Among the evaluation methods of education, observation is suitable for children. It is quite difficult to examine the inherent and relational phenomena using a documented inspection tool, with cognitive and verbal abilities weaker than adults. Careful observation of child behavior or developmental changes helps a lot in forming the curriculum, the classroom environment, and in selecting educational content or teaching-learning methods.

Types of observational recording methods include anecdotal records, time sampling, event sampling, checklists, and rating scale method, and should be considered how it will be recorded.

Children's play seems simple, but it's actually complex human behavior. Researchers point out that children's playing skill is related to social skills, intelligence, language development, and creativity. In childhood education, play is considered an education, and play is considered to be the best way to provide learning opportunities suitable for development. The educational value of play in childhood education can be viewed in four aspects: learning, education, evaluation and treatment.

Playing is a natural evaluation tool because it allows to examine the development of children in all areas of development. Observing children's play for evaluation is not new. It is a method that has been done for a long time.

It is desirable for the indoor playroom of the childhood education institution is to divide the entire space into several play stations and provide each station with facilities or playgrounds needed for play.

Children in well-maintained indoor playrooms have more team activities, social interaction and cooperative play, and positive play interactions appear.

A good layout of the play station in the playroom will have the following effects.

First, the boundaries between play stations are clear, so children who are playing in other stations can play without being disturbed. Second, the games and space needed for each station of play are provided so that children can play various games and more advanced forms of play. Third, since children choose the game they want, the decision-making ability, autonomy, independence, and initiative are enhanced.

The play station includes the followings: language & literature, mathematics/puzzles, science, art, role play, water/sand play, sculpture, blocks, music, woodworking, and computer station, etc. It is configured according to each childhood education institution facility, but many aspects should be taken into consideration when deploying.

Before this invention, there was no method for a quantitative analysis of the degree of development of a child such as perceptual development, physical development, intelligence development, emotional development or social performance of each child in the play station, so the degree of development of each child had to be relied upon by the teacher's subjective judgment.

In this regard, the present invention intends to propose a system for quantitatively analyzing the time of occupancy in the various stations (language & literature, mathematics/puzzles, science, art, role play, water/sand play, sculpture, blocks, music, woodworking and computer station, etc.) based on the data received from the wireless communication devices carried on a child in an educational facilities.

### PRIOR ART LITERATURES

### Patent Literatures

Republic of Korea Patent Disclosure Gazette No.10-2004-0074056.

### CONTENT OF THE INVENTION

### Object Task to Solve

An embodiment of the present invention is to generate data of the degree of development of each child by quantitatively analyzing statistical information from the occupancy of the child in at least one of a language & literature, mathematics/puzzles, science, art, role play, water/sand play, sculpture, blocks, music, woodworking and computer station, based on location data received from a wireless communication devices, that is carried on a child working in various stations within an educational facility.

In addition, an embodiment of the present invention is to generate data of the degree of development of each child by quantitatively analyzing the time spent occupied in various stations corresponding to the location data of a child by tracking and analyzing of the images of the child recorded child's face or iris with multiple cameras.

### Methods to Solve the Task

One embodiment of the present invention for solving technical problems is using a system for quantitative analysis of educational activities of a child comprising: a communication module that emits a magnetic signal with a unique identification (ID) and location data corresponding to a station at predetermined constant interval times, that is carried on a child working in various stations within an educational facility; an intermediary module that classifies the magnetic signal received from the communication module by the unique identification (ID) and sends the classified magnetic signal to an analysis server; and the analysis server for calculating time spent occupied in various stations corresponding to the location data for each unique identification (ID) from the magnetic signal received from the intermediary module, and generating quantitative statistical information from the child's occupancy.

Preferably, the communication module emits magnetic signals through any one wireless communication of beacon, Near Field Communication (NFC), Zigbee, or Bluetooth from at least one of a badge, necklace, watch, name tag, bracelet, anklet, and shoe.

The various stations include language & literature, mathematics/puzzles, science, art, role play, water/sand play, sculpture, blocks, music, woodworking, computer station, etc.

The analysis server comprising: a sorting unit for matching the position data with the unique identification (ID) by analyzing the magnetic signals received from the intermediary module; a computation unit for calculating numerical data for time of occupancy in one of the various stations from the corresponding position data and the time data; and a quantitative analysis unit for generating quantitative statistical information based on the time of occupancy of the child in one of the various stations.

### Effect of the Invention

An embodiment of the present invention has the effect of generating data regarding the degree of development of each child by quantitatively analyzing the time spent occupied in various stations corresponding to the location data of the child in one of the various stations of inside or outside of an education facility such as language & literature, mathematics/puzzles, science, art, role play, water/sand play, sculpture, blocks, music, woodworking and computer station, etc., based on data received from a wireless communication device carried on a child

In addition, an embodiment of the present invention has the effect of making data regarding the degree of development of each child by quantitatively analyzing the time spent occupied in various stations from the corresponding position data and the time data of children by tracking and analyzing the recorded images (Facial recognition or Iris recognition) of child with multiple cameras.

### BRIEF EXPLANATIONS ON THE FIGURES

FIG. 1 is a block diagram showing a system for quantitative analysis of educational activities of a child according to an embodiment of the present invention.

FIG. 2 is a block diagram showing a recording module of the educational activities quantitative analysis system of the child according to an embodiment of the present invention.

FIG. 3 is a block diagram showing an analysis server system for quantitative analysis of educational activities of a child according to an embodiment of the present invention.

### DETAILED CONTENTS TO IMPLEMENT THE INVENTION

Specific features and advantages of the present invention will become more apparent from the following detailed description based on the accompanying drawings. Prior to this, based on the principle that an inventor can properly define the concept of a term in order to describe his invention in the best possible way. It should be interpreted as meaning and concept corresponding to the technical idea of the present invention. In addition, when it is determined that the detailed description of the known function and its configuration related to the present invention may unnecessarily obscure the subject matter of the present invention, it should be noted that the detailed description is omitted.

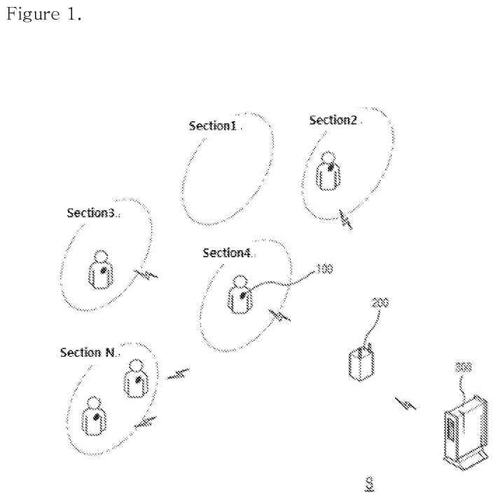

As illustrated in FIG. 1 a system (S) for quantitative analysis of educational activities of a child according to an embodiment of the present invention comprising: The communication module 100 is carried on the children who are active in various stations and emits a magnetic signal including a unique identification (ID) and location data matched with the station at a predetermined constant interval times; Intermediary module 200 for classifying the magnetic signal received from the communication module 100 by the unique identification (ID) and sends the classified magnetic signal to the analysis server 300; Analysis server 300 for calculating the time spent occupied in various stations corresponding to the location data for each unique identification (ID) from the magnetic signal received from the intermediary module 200, and generating quantitative statistical information from the occupancy of the child.

Specifically, the communication module 100 according to an embodiment of the present invention emits magnetic signals with any one of wireless communication; beacons, Near Field Communication (NFC), Zigbee or Bluetooth.

In addition, the communication module 100 may be carried on a child in the form of a brooch, detachable from clothes of the child, or may be configured to be detachable from a badge, necklace, watch, name tag, bracelet, anklets or shoes. That is, the communication module 100 may be configured in a form that can be attached or carried on the body of the child.

Meanwhile, the intermediary module 200 is installed in any one of various stations in an educational institute to receive magnetic signals in real time from the plurality of communication modules 100, The received magnetic signals are classified by unique identification (ID) and transmitted to the analysis server 300. The intermediary module 200 may be composed of a plurality.

In this case, the various stations may be set to the station 1 to the station n by the administrator. And it may be divided into any one of the following sections: language & literature, mathematics/puzzles, science, art, role play, water/sand play, sculpture, blocks, music, woodworking and computer station. but the present invention is not limited thereto.

In addition, the intermediary module 200 may be configured to transmit the magnetic signals classified by the unique identification (ID) to the set guardian terminal in addition to the analysis server 300.

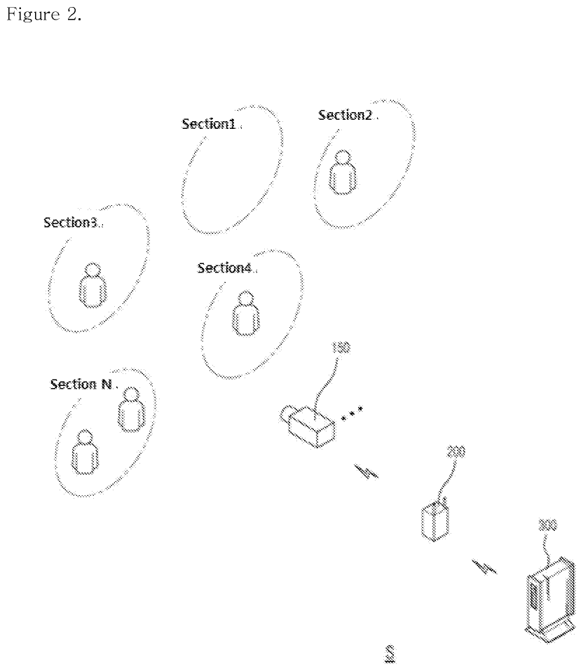

On the other hand, as shown in FIG. 2 a system (S) for quantitative analysis of educational activities of a child according to an embodiment of the present invention further comprising: the recording module (150) that further includes recognition of the image of the child, recorded in real time, and transmits recorded information tracked in time series to the intermediary module (200).

In this case, the recording module 150 may be provided in plural, and the facial image recognition from the recorded face image of the child is performed by facial recognition or iris recognition that detects a face image that matches the previously identified face image.

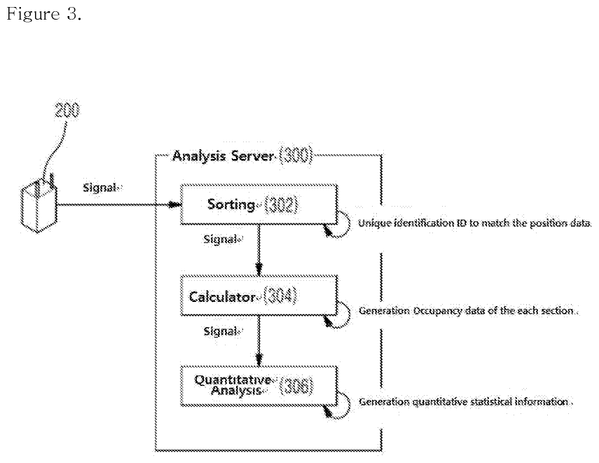

Referring to FIG. 3, the analysis server (300) is configured comprising: sorting unit(302) for matching the position data by analyzing the magnetic signal received from the intermediary module 200 by a unique identification (ID), a computation unit (304) for calculating numerical data for time of occupancy in one of the various stations from the corresponding position data and the time data; and a quantitative analysis unit (306) for generating quantitative statistical information based on the time of occupancy of the child in one of the various stations.

At this time, the quantitative statistical information includes a numerical value of the time spent occupied in each station by a child and the time series data on the graph.

In addition, the sorting unit (302) sorts the recording information received from the intermediary module (200) by the unique identification (ID) to match the position data. The calculation unit (304) generates information about time spent occupied for each station by calculating time data occupied in a station corresponding to the position data matched with the recording information.

In addition, the quantitative analysis unit (306) may generate the degree of development corresponding to the corresponding station based on the quantitative statistical information that quantifies the for time of occupancy in one of the various stations from the corresponding position data and the time data of the child.

For example, when a particular child stays for a time exceeding a criterion in the science station, it can show the degree of development of the scientific analytical thinking of the child.

As described above, an embodiment of the present invention is to generate data of the degree of development of a child by quantitatively analyzing statistical information from the occupancy of the child in various stations such as a language & literature, mathematics/puzzles, science, art, role play, water/sand play, sculpture, blocks, music, woodworking, and computer station, based on location data received from a wireless communication devices, that is carried on a child working in various stations within an educational facility.

In addition, an embodiment of the present invention is to generate data of the degree of development of each child by quantitatively analyzing the time spent occupied in various stations corresponding to the location data of a child by tracking and analyzing of the images of the child recorded child's face or iris with multiple cameras and the time series data on the graph.

So far, the present invention has been described and illustrated in connection with a preferred embodiment for illustrating the technical idea of the present invention. However, those skilled in the art will understand that the present invention is not limited to the configuration and operation as shown and described, and that many changes and modifications can be made to the present invention without departing from the scope of the technical idea. Accordingly, all such suitable changes, modifications, and equivalents should be considered to be within the scope of the present invention.

### LEGENDS

S: System for quantitative analysis of educational activities of a child

100: Communication module

150: Recording module

200: Intermediary module

300: Analysis server

302: Sorting unit

304: Computation unit

306: Quantitative analysis unit

What is claimed is:

1. A system for quantitative analysis of educational activities of a child comprising:
(1) a communication module, that emits a magnetic signal with a unique identification (ID) and location data corresponding to a station at predetermined constant interval times, that is carried on a child working in various stations within an educational facility;
(2) an intermediary module that classifies the magnetic signal received from said communication module by the unique identification (ID) and sends the classified magnetic signal to an analysis server; and
(3) said analysis server for calculating time spent occupied in various stations corresponding to the location data for each unique identification (ID) from the magnetic signal received from said intermediary module, and generating quantitative statistical information from the occupancy of the child.

2. The system of claim 1, wherein said communication module emits magnetic signals through any one of beacon, Near Field Communication (NFC), Zigbee or Bluetooth form at least one of a badge, necklace, watch, name tag, bracelet, anklet, and shoe.

3. The system of claim 1, wherein said various stations are at least one stations of language & literature, mathematics/puzzles, science, art, role play, water/sand play, sculpture, blocks, music, woodworking and computer station.

4. The system of claim 1, wherein said analysis server comprising:
a sorting unit for matching the position data by analyzing the magnetic signal received from the intermediary module by the unique identification (ID);
a computation unit for calculating numerical data for time of occupancy in one of the various stations from the corresponding position data and the time data; and
a quantitative analysis unit for generating quantitative statistical information based on the time of occupancy of the child in one of the various stations.

5. The system of claim 1 further comprising:
a recording module for capturing the image of the child taken in real time to transfer said image information tracked in time series to said intermediary module wherein said recording module is installed in plurality around the stations for the purpose of recognizing identification from the captured image of the child by matching with previously identified image of the child.

6. The system of claim 5, wherein said image of the child is child's face image or iris image.
